(19) United States
(12) Patent Application Publication
(10) Pub. No.: US 2012/0207465 A1
(43) Pub. Date: Aug. 16, 2012

(54) DUSTPROOF STRUCTURE AND IMAGING APPARATUS

(75) Inventors: Kazutaka OZAWA, Tokyo (JP); Tsuyoshi Kanai, Tokyo (JP)

(73) Assignee: Sony Corporation, Tokyo (JP)

(21) Appl. No.: 13/347,975

(22) Filed: Jan. 11, 2012

(30) Foreign Application Priority Data
Feb. 15, 2011 (JP) 2011-029883

(51) Int. Cl. G03B 17/00; F16H 19/02

(52) U.S. Cl. 396/439; 74/89

(57) ABSTRACT

A dustproof structure includes: at least one fixed member disposed in an immobile manner; and a rotating member rotatable relative to the fixed member, wherein a clearance is formed between the fixed member and the rotating member, the clearance communicating with an external space positioned outside the fixed member and the rotating member and with an internal space positioned between the fixed member and the rotating member and extending in the direction in which the rotating member is rotated, and a plurality of recesses are formed in the fixed member, the recesses positioned in the internal space, extending in the rotating direction, and arranged in a direction other than the rotating direction.

### FIELD

The present disclosure relates to a technical field of dustproof structures and imaging apparatus. The present disclosure particularly relates to a technical field of preventing dust reaching a deep portion of an internal space by forming a plurality of recesses arranged in a direction other than the direction of rotation of a rotating member that is rotated relative to a fixed member.

### BACKGROUND

Video camcorders, still cameras, and a variety of other imaging apparatus include a lens barrel that accommodates an optical system formed of a lens and other optical components and perform imaging by capturing an image of a subject through the optical system in the lens barrel.

Some imaging apparatus of this type include an optical operation unit having a fixed member and a rotating member that is rotated relative to the fixed member. In the optical operation unit, when the rotating member is rotated relative to the fixed member, for example, a group of lenses in the lens barrel is moved in the optical direction for zooming or focusing, or iris blades are opened or closed to adjust the amount of light.

In the imaging apparatus described above, a predetermined clearance is so formed between the fixed member and the rotating member that the rotating member can be smoothly rotated relative to the fixed member.

The clearance formed between the fixed member and the rotating member, however, disadvantageously allows dust, dirt, moisture, and other foreign matter to enter an internal space located between the fixed member and the rotating member from an external space located outside the fixed member and the rotating member through the clearance. The dust and other foreign matter having entered the internal space may block gaps between the fixed member and the rotating member and hamper smooth rotation of the rotating member relative to the fixed member.

To address the problem, some imaging apparatus of related art are configured to prevent dust and other foreign matter from entering the internal space by disposing a U-shaped packing between the fixed member and the rotating member (see JP-A-5-241277, for example).

### SUMMARY

In the imaging apparatus described in JP-A-5-241277, however, the U-shaped packing is disposed in the clearance or in the vicinity thereof. In this structure, dust and other foreign matter tend to accumulate on and degrade the packing.

The degraded packing may not be able to prevent the entry of dust and other foreign matter.

It is therefore desirable to provide a dustproof structure and an imaging apparatus that solve the problem described above, that is, prevent dust from reaching a deep portion of an internal space to ensure smooth rotation of a rotating member relative to a fixed member.

An embodiment of the present disclosure is directed to a dustproof structure including at least one fixed member disposed in an immobile manner and a rotating member rotatable relative to the fixed member. A clearance is formed between the fixed member and the rotating member, the clearance communicating with an external space positioned outside the fixed member and the rotating member and with an internal space positioned between the fixed member and the rotating member and extending in the direction in which the rotating member is rotated, and a plurality of recesses are formed in the fixed member, the recesses positioned in the internal space, extending in the rotating direction, and arranged in a direction other than the rotating direction.

In the dustproof structure, dust and other foreign matter having entered the internal space through the clearance therefore enter the plurality of recesses.

In the dustproof structure described above, it is preferred that the recesses are open in the direction perpendicular to the axis of rotation of the rotating member.

Since the recesses are open in the direction perpendicular to the axis of rotation of the rotating member, dust and other foreign matter tend to enter the recesses.

In the dustproof structure described above, it is preferred that, among the plurality of recesses, the direction in which the opening of the recess closest to the clearance faces is the direction in which the clearance faces.

Since, among the plurality of recesses, the direction in which the opening of the recess closest to the clearance faces is the direction in which the clearance faces, much of the dust and other foreign matter having entered through the clearance enter the recess positioned closest to the clearance.

In the dustproof structure described above, it is preferred that the plurality of recesses are formed to be arranged in the direction perpendicular to the rotating direction.

Since the plurality of recesses are formed to be arranged in the direction perpendicular to the rotating direction, dust and other foreign matter having entered through the clearance do not tend to reach a deep portion of the internal space.

In the dustproof structure described above, it is preferred that the plurality of recesses are separated by standing walls, that an outer edge of each of the standing walls that faces the clearance is a cornered portion having a square-cornered shape, and that an outer edge of each of the standing walls that faces a deep portion of the internal space is a curved portion having a curved shape.

Since an outer edge of each of the standing walls that faces the clearance is a cornered portion having a square-cornered shape, and an outer edge of the standing wall that faces a deep portion of the internal space is a curved portion having a curved shape, dust and other foreign matter having entered the recess positioned on the clearance side do not tend to travel over the standing wall toward the recess located in a deeper position in the internal space, whereas dust and other foreign matter having entered the recess positioned in the deeper portion in the internal space tend to travel over the standing wall toward the recess positioned on the clearance side.

In the dustproof structure described above, it is preferred that the rotating member has a receiving surface formed thereon, the receiving surface positioned in the internal space and so inclined that the receiving surface approaches the axis of rotation of the rotating member as extending toward a deep portion of the internal space, and that the receiving surface is positioned to face the opening of at least one of the recesses.

Since the rotating member has a receiving surface formed thereon, the receiving surface positioned in the internal space and so inclined that the receiving surface approaches the axis of rotation of the rotating member as extending toward a deep portion of the internal space, and the receiving surface is positioned to face the opening of at least one of the recesses, dust and other foreign matter that travel over the standing walls tend to come into contact with the receiving surface.

In the dustproof structure described above, it is preferred that the fixed member has a discharge hole formed therein, the discharge hole communicating with at least one of the recesses and the external space.

Since the fixed member has a discharge hole formed therein, the discharge hole communicating with at least one of the recesses and the external space, dust and other foreign matter having entered the internal space exit through the discharge hole to the external space.

In the dustproof structure described above, it is preferred that the plurality of recesses are separated by standing walls, and that a cutout is so formed through each of the standing walls that the cutout allows the recesses adjacent to the standing wall to communicate with each other.

Since the plurality of recesses are separated by standing walls, and a cutout is so formed through each of the standing walls that the cutout allows the recesses adjacent to the standing wall to communicate with each other, dust and other foreign matter having entered the internal space enter an recess and then enter an adjacent recess formed next to the recess through the cutout.

In the dustproof structure described above, it is preferred that the discharge hole and the cutouts are formed in positions set apart in the direction in which the rotating member is rotated.

Since the discharge hole and the cutouts are formed in positions set apart in the direction in which the rotating member is rotated, dust and other foreign matter having entered a recess through the discharge hole do not tend to enter adjacent recesses formed next to the recess.

In the dustproof structure described above, it is preferred that a space continuous with the clearance in the internal space is so formed that the space widens as extending toward a deep portion of the internal space.

Since a space continuous with the clearance in the internal space is so formed that the space widens as extending toward a deep portion of the internal space, dust and other foreign matter do not tend to block the gap between the fixed member and the rotating member.

In the dustproof structure described above, it is preferred that a packing is disposed in the internal space, the packing having an annular shape and including an attachment portion that is attached to the fixed member and a deformable portion that is elastically deformable and elastically deformed and pressed against the rotating member, and that the packing is disposed behind the plurality of recesses in the internal space.

Since the packing is disposed in the internal space behind the plurality of recesses therein, the packing prevents dust and other foreign matter not having entered the plurality of recesses from reaching a deep portion of the internal space.

In the dustproof structure described above, it is preferred that the deformable portion of the packing is positioned to be set apart from the fixed member.

Since the deformable portion of the packing is positioned to be set apart from the fixed member, the fixed member does not restrict deformation of the deformable portion.

In the dustproof structure described above, it is preferred that standing walls that form the recesses are provided in the internal space, and that the standing walls and the packing form a concave space disposed next to the recess located in the deepest position in the internal space and extending in the rotating direction.

The concave space formed by the standing walls and the packing, disposed next to the recess located in the deepest position in the internal space, and extending in the rotating direction, along with the plurality of recesses, allows the distance of the path along which dust and other foreign matter enter to be increased.

In the dustproof structure described above, it is preferred that the deformable portion of the packing is formed of a first portion protruding from the attachment portion and a second portion continuous with the first portion and bent relative thereto.

Since the deformable portion of the packing is formed of the first portion protruding from the attachment portion and the second portion continuous with the first portion and bent relative thereto, the rigidity of the deformable portion is increased.

In the dustproof structure described above, it is preferred that the rotating member is formed of an operation portion and an inner placement portion, the operation portion having an annular shape and rotated when operated and the inner placement portion extending inward from an inner circumferential surface of the operation portion, and that the deformable portion of the packing is so pressed against the inner placement portion of the rotating member that the deformable portion is inclined to the inner placement portion.

Since the inner placement portion is provided as part of the rotating member, and the deformable portion of the packing is so pressed against the inner placement portion of the rotating member that the deformable portion is inclined to the inner placement portion, the area where the packing comes into contact with the rotating member decreases.

In the dustproof structure described above, it is preferred that a plurality of sliding portions are provided as part of the inner placement portion of the rotating member, the plurality of sliding portions sliding relative to part of the fixed member when the rotating member is rotated relative to the fixed member, and that the plurality of sliding portions are positioned behind the packing in the internal space.

Since the plurality of sliding portions are provided as part of the inner placement portion of the rotating member and the plurality of sliding portions are positioned behind the packing in the internal space, dust and other foreign matter will not block the interfaces between the sliding portions of the rotating member and the fixed member.

Another embodiment of the present disclosure is directed to an imaging apparatus including a lens barrel in which an optical system is disposed, an imaging device that converts an optical image captured through the optical system into an electric signal, and an optical operation unit that manipulates the optical system. The optical operation unit includes at least one fixed member disposed in an immobile manner and a rotating member rotatable relative to the fixed member. A clearance is formed between the fixed member and the rotating member, the clearance communicating with an external space positioned outside the fixed member and the rotating member and with an internal space positioned between the fixed member and the rotating member and extending in the direction in which the rotating member is rotated, and a plurality of recesses are formed in the fixed member, the recesses positioned in the internal space, extending in the rotating direction, and arranged in a direction other than the rotating direction.

In the imaging apparatus, dust and other foreign matter having entered the internal space through the clearance therefore enter the plurality of recesses.

The dustproof structure according to the embodiment of the present disclosure includes at least one fixed member disposed in an immobile manner and a rotating member rotatable relative to the fixed member. A clearance is formed between the fixed member and the rotating member, the clearance communicating with an external space positioned outside the fixed member and the rotating member and with an internal space positioned between the fixed member and the rotating member and extending in the direction in which the rotating member is rotated, and a plurality of recesses are formed in the fixed member, the recesses positioned in the internal space, extending in the rotating direction, and arranged in a direction other than the rotating direction.

The plurality of recesses therefore prevent dust from reaching a deep portion of the internal space, which ensures smooth rotation of the rotating member relative to the fixed member.

In the present disclosure described above, the recesses may be open in the direction perpendicular to the axis of rotation of the rotating member.

Dust and other foreign matter therefore tend to enter the plurality of recesses, whereby entry of the dust into a deep portion of the internal space can be effectively suppressed.

In the present disclosure described above, among the plurality of recesses, the direction in which the opening of the recess closest to the clearance faces may be the direction in which the clearance faces.

The above configuration allows much of the dust and other foreign matter having entered through the clearance to enter the recess positioned closest to the clearance, whereby the dust and other foreign matter will not reach a deep portion of the internal space.

In the present disclosure described above, the plurality of recesses may be formed to be arranged in the direction perpendicular to the rotating direction.

Dust and other foreign matter having entered through the clearance therefore do not tend to reach a deep portion of the internal space, whereby entry of the dust into the deep portion of the internal space can be effectively suppressed.

In the present disclosure described above, the plurality of recesses may be separated by standing walls. An outer edge of each of the standing walls that faces the clearance may be a cornered portion having a square-cornered shape, and an outer edge of each of the standing walls that faces a deep portion of the internal space may be a curved portion having a curved shape.

Each of the thus shaped standing walls does not easily allow dust and other foreign matter having entered the recess positioned on the clearance side to travel over the standing wall toward the recess located in the deeper position in the internal space but easily allows dust and other foreign matter having entered the recess located in the deeper position in the internal space to travel over the standing wall toward the recess positioned on the clearance side, whereby the amount of dust and other foreign matter that reach a deep portion of the internal space can be reduced.

In the present disclosure described above, the rotating member may have a receiving surface formed thereon, the receiving surface positioned in the internal space and so inclined that the receiving surface approaches the axis of rotation of the rotating member as extending toward a deep portion of the internal space, and the receiving surface may be positioned to face the opening of at least one of the recesses.

Dust and other foreign matter that travel over the standing walls therefore tend to come into contact with the receiving surface and enter the recesses, whereby the dust and other foreign matter will not reach a deep portion of the internal space.

In the present disclosure described above, the fixed member may have a discharge hole formed therein, the discharge hole communicating with at least one of the recesses and the external space.

The thus formed discharge hole allows dust and other foreign matter having entered the internal space to exit to the external space, whereby the dust and other foreign matter will not accumulate in the internal space.

In the present disclosure described above, the plurality of recesses may be separated by standing walls, and a cutout may be so formed through each of the standing walls that the cutout allows the recesses adjacent to the standing wall to communicate with each other.

The thus formed cutout allows dust and other foreign matter having entered the internal space to exit to the external space, whereby the dust and other foreign matter will not accumulate in the internal space.

In the present disclosure described above, the discharge hole and the cutouts may be formed in positions set apart in the direction in which the rotating member is rotated.

As a result, even when dust and other foreign matter enter the recess communicating with the discharge hole therethrough, the dust and other foreign matter having entered the recess do not tend to enter adjacent recesses, whereby the dust and other foreign matter will not reach a deep portion of the internal space.

In the present disclosure described above, a space continuous with the clearance in the internal space may be formed such that the space widens as extending toward a deep portion of the internal space.

Dust and other foreign matter will therefore not block the gap between the fixed member and the rotating member, which ensures smooth rotation of the rotating member.

In the present disclosure described above, a packing may be disposed in the internal space, the packing having an annular shape and including an attachment portion that is attached to the fixed member and a deformable portion that is elastically deformable and elastically deformed and pressed against the rotating member, and the packing may be disposed behind the plurality of recesses in the internal space.

The packing therefore prevents dust and other foreign matter not having entered the plurality of recesses from reaching a deep portion of the internal space.

In the present disclosure described above, the deformable portion of the packing may be positioned to be set apart from the fixed member.

Since the deformable portion will not come into contact with the fixed member, the deformable portion can freely deform, whereby the packing reliably functions in a satisfactory manner.

In the present disclosure described above, standing walls that form the recesses may be provided in the internal space, and the standing walls and the packing may form a concave space disposed next to the recess located in the deepest position in the internal space and extending in the rotating direction.

The thus formed concave space, along with the plurality of recesses, allows the distance of the path along which dust and other foreign matter enter to be increased, whereby entry of the dust and other foreign matter into a deep portion of the internal space can be suppressed accordingly.

In the present disclosure described above, the deformable portion of the packing may be formed of a first portion protruding from the attachment portion and a second portion continuous with the first portion and bent relative thereto.

As a result, the deformable portion has high rigidity and the packing will not be plastically deformed or damaged.

In the present disclosure described above, the rotating member may be formed of an operation portion and an inner placement portion, the operation portion having an annular shape and rotated when operated and the inner placement portion extending inward from an inner circumferential surface of the operation portion, and the deformable portion of the packing may be so pressed against the inner placement portion of the rotating member that the deformable portion is inclined to the inner placement portion.

The area where the packing is in contact with the rotating member is therefore small, that is, the packing exerts only a small load on the rotating member when the rotating member is rotated, which ensures smooth rotation of the rotating member.

In the present disclosure described above, a plurality of sliding portions may be provided as part of the inner placement portion of the rotating member, the plurality of sliding portions sliding relative to part of the fixed member when the rotating member is rotated relative to the fixed member, and the plurality of sliding portions may be positioned behind the packing in the internal space.

Dust and other foreign matter will therefore not block the interfaces between the sliding portions of the rotating member and the fixed member, which ensures smooth rotation of the rotating member.

The imaging apparatus according to the embodiment of the present disclosure includes the lens barrel in which the optical system is disposed, the imaging device that converts an optical image captured through the optical system into an electric signal, and the optical operation unit that manipulates the optical system. The optical operation unit includes at least one fixed member disposed in an immobile manner and the rotating member rotatable relative to the fixed member. The clearance is formed between the fixed member and the rotating member, the clearance communicating with the external space positioned outside the fixed member and the rotating member and with an internal space positioned between the fixed member and the rotating member and extending in the direction in which the rotating member is rotated, and a plurality of recesses are formed in the fixed member, the recesses positioned in the internal space, extending in the rotating direction, and arranged in a direction other than the rotating direction.

In the configuration described above, the plurality of recesses prevent dust from reaching a deep portion of the internal space, which ensures smooth rotation of the rotating member relative to the fixed member.

### BRIEF DESCRIPTION OF THE DRAWINGS

FIG. 1, along with FIGS. 2 to 10, shows the best mode for carrying out the present disclosure and is a schematic perspective view of an imaging apparatus;

FIG. 2 is a perspective view of an optical operation unit;

FIG. 3 is a cross-sectional view of the optical operation unit;

FIG. 4 is an enlarged cross-sectional view showing part of the optical operation unit;

FIG. 5 is an enlarged cross-sectional view showing standing walls and other components;

FIG. 6 is an enlarged perspective view showing a discharge hole, a cutout, and other components formed on the front side;

FIG. 7 an enlarged perspective view showing a discharge hole, a cutout, and other components formed on the back side;

FIG. 8 is an enlarged bottom view of the optical operation unit;

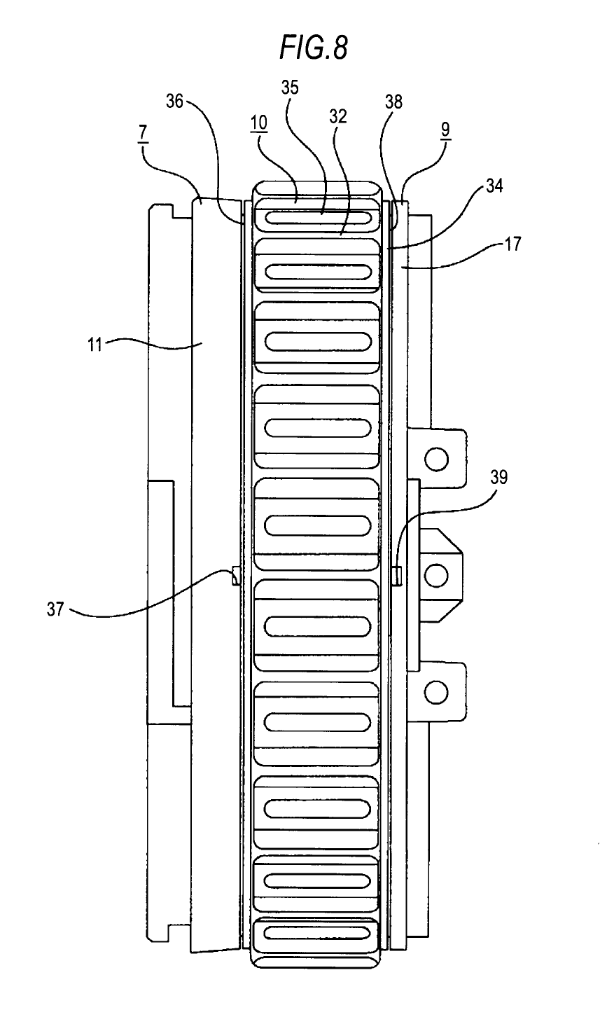

FIG. 9 is an enlarged cross-sectional view for describing paths along which dust and other foreign matter travel and other components; and

FIG. 10 is a block diagram of the imaging apparatus.

### DETAILED DESCRIPTION

Modes for carrying out the present disclosure will be described below with reference to the accompanying drawings.

In the following best mode, an imaging apparatus according to an embodiment of the present disclosure is used in a video camcorder, and a dustproof structure according to another embodiment of the present disclosure is a dustproof structure provided in the video camcorder. It is noted that the present disclosure is not necessarily applied to a video camcorder but is widely applicable to a variety of imaging apparatus incorporated in a still camera and other apparatus and dustproof structures provided in the imaging apparatus.

In the following description, the front-back, up-down, and right-left directions are defined relative to a user who uses a video camcorder to capture an image. That is, the subject side is the front side, and the user side is the back side.

The front-back, up-down, and right-left directions used below are used for convenience of description, and the directions defined as described above do not impose any limitation on implementation of the present disclosure.

### [Schematic Configuration of Imaging Apparatus]

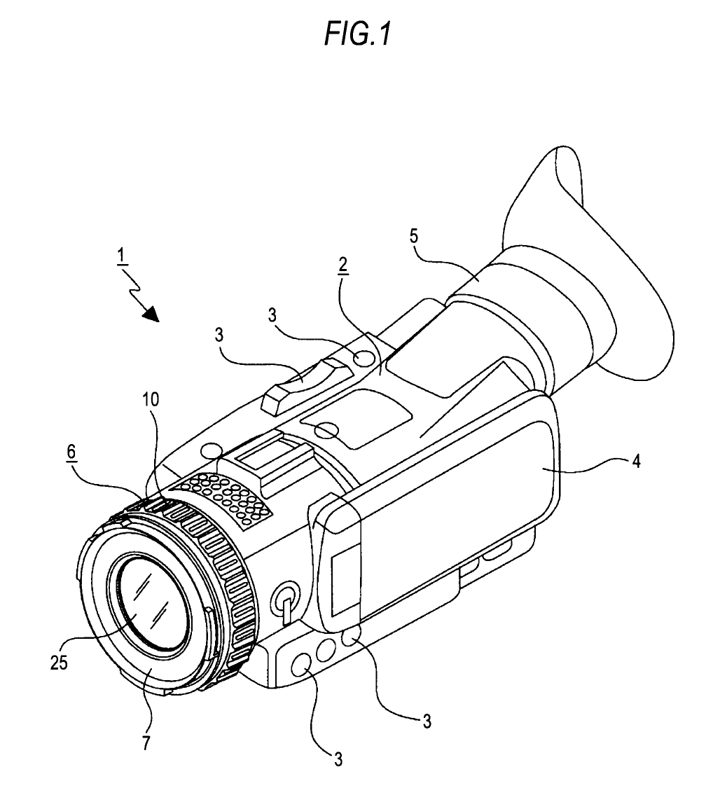

An imaging apparatus 1 has necessary portions disposed inside and outside a body 2 (see FIG. 1). A plurality of operation sections 3, 3, . . . are disposed on the exterior surface of the body 2. Examples of the operation sections 3, 3, . . . include a power on/off button, a recording button, a zoom switch, and a mode switching knob.

The imaging apparatus 1 also includes a display panel 4, and a viewfinder 5, and other sections.

The display panel 4 can be opened and closed sideways relative to the body 2 and has a liquid crystal display or any other display screen (not shown). The display screen of the display panel 4 allows a user to check the state of a subject when capturing an image thereof and can display and reproduce a captured image or video on the display screen.

The viewfinder 5 is disposed in a back end portion of the body 2 and allows the user to check the state of the subject when capturing an image thereof.

The body 2 has a lens barrel (not shown) disposed therein. The lens barrel accommodates an optical system formed of a plurality of groups of lenses, iris blades, and other components. Zooming or focusing is performed by moving a group of lenses in the optical direction, or the iris blades are opened or closed to adjust the amount of light.

An imaging device (not shown) is disposed downstream of the groups of lenses. The imaging device is, for example, a CCD (charge coupled device) or a CMOS (complementary metal-oxide semiconductor) device.

### [Structure of Optical Operation Unit (Dustproof Structure)]

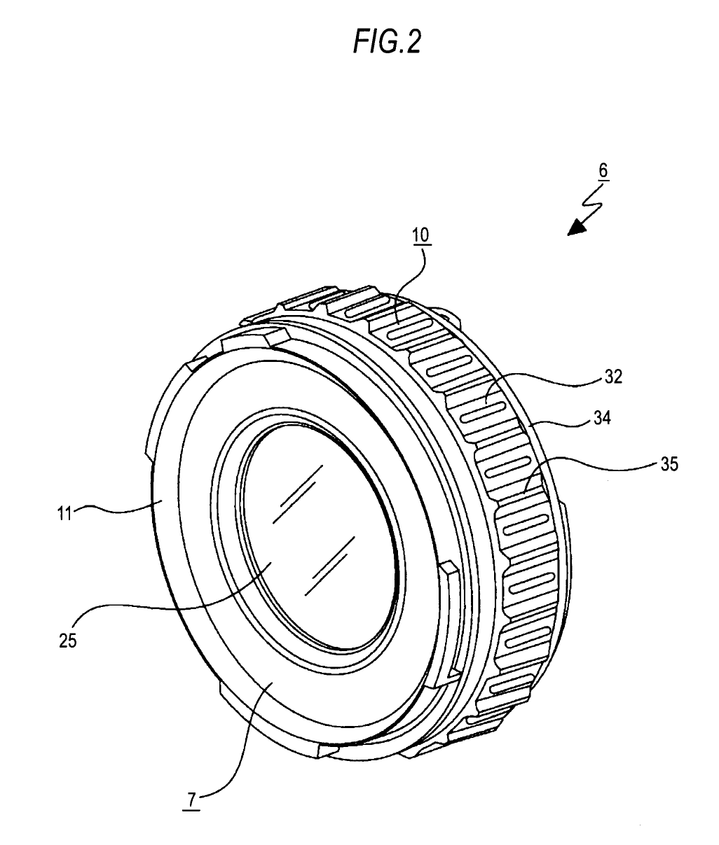

An optical operation unit 6 that manipulates the optical system, which is formed of the groups of lenses and other components, is provided in an front end portion of the body 2 (see FIGS. 1 and 2). A dustproof structure is provided in the optical operation unit 6 to handle dust, moisture, and other foreign matter having entered the space inside the optical operation unit 6.

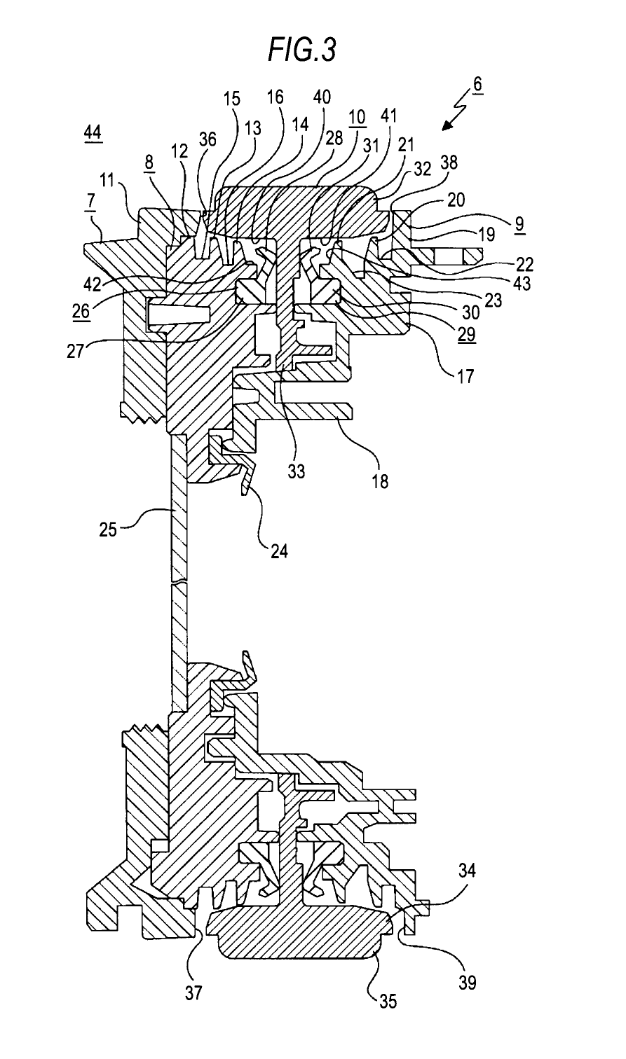

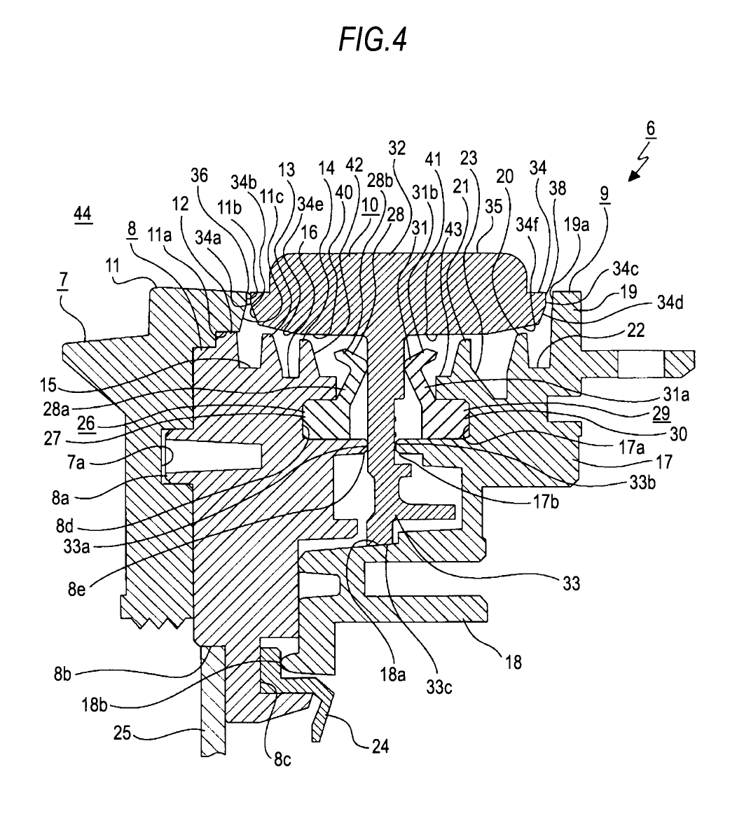

The optical operation unit 6 includes a first fixed member 7, a second fixed member 8, and a third fixed member 9 that are disposed in an immobile manner and a rotating member 10 that is rotated relative to the first fixed member 7, the second fixed member 8, and the third fixed member 9 (see FIGS. 3 and 4). The first fixed member 7, the second fixed member 8, and the third fixed member 9 are disposed in this order from the front side.

The first fixed member 7 has a substantially annular shape whose axis extends in the front-back direction and has an insertion recess 7a that is open backward. The insertion recess 7a has an annular shape. An outer circumferential portion 11 of the first fixed member 7 protrudes backward more than the other portions of the first fixed member 7, and an annular clearing recess 11a that is open backward and inward is formed along the inner circumference of the outer circumferential portion 11. The back surface of the outer circumferential portion 11 on the outer circumferential side is formed as an opposing surface 11b, and a surface continuous with the opposing surface 11b on the inner circumference side and extending inward is formed as an inclined surface 11c, which extends forward as extending inward.

The second fixed member 8 has an annular shape whose axis extends in the front-back direction and has an annular insertion protrusion 8a that protrudes forward. A circular attachment recess 8b that is open forward and inward is formed in an inner circumferential portion of the second fixed member 8. An annular placement recess 8c is formed behind the attachment recess 8b in the inner circumferential portion of the second fixed member 8. The placement recess 8c is open backward.

An annular press-fit recess 8d that is open backward is formed in a position close to the outer circumference of the second fixed member 8. A portion continuous with the inner side of the press-fit recess 8d and protruding backward is provided as part of the second fixed member 8 and called an annular sliding protrusion 8e.

A first standing wall 12, a second standing wall 13, and a third standing wall 14, each of which protrudes outward and has an annular shape, are provided in this order from the front side on the outer circumferential surface of the second fixed member 8. The first standing wall 12, the second standing wall 13, and the third standing wall 14 are so positioned that they are set apart from each other in the front-back direction; the space between the first standing wall 12 and the second standing wall 13 forms a first recess 15, and the space between the second standing wall 13 and the third standing wall 14 forms a second recess 16.

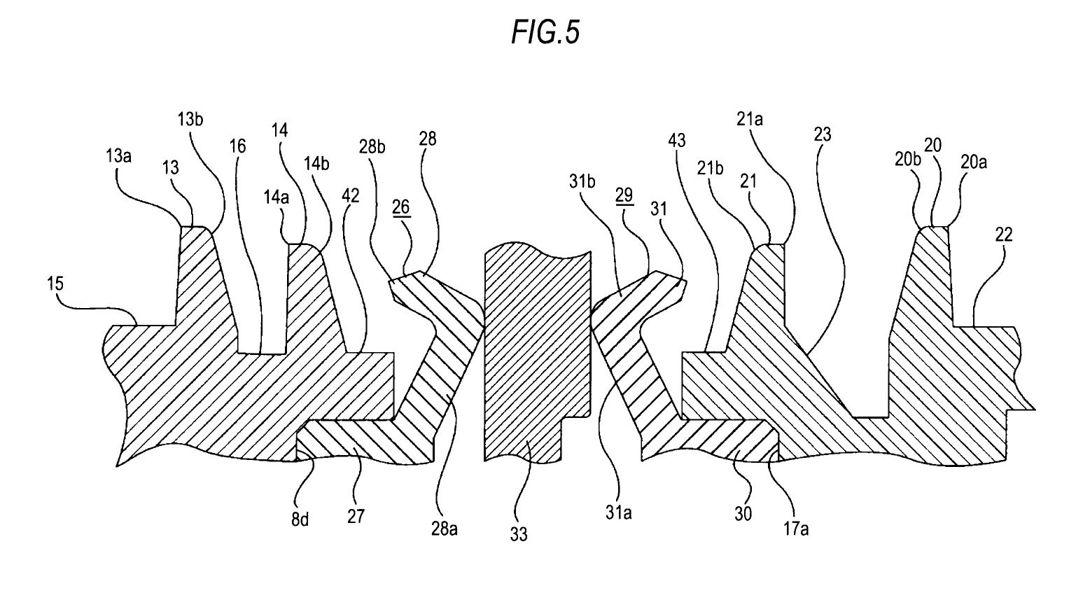

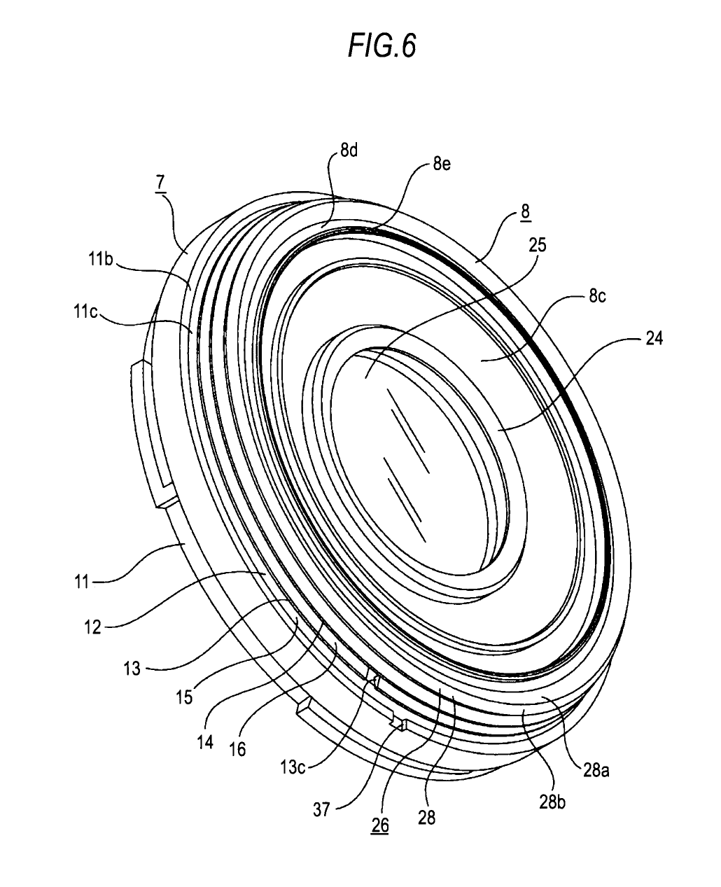

The second standing wall 13 has a cornered portion 13a so formed that the front edge of the circumferential end of the second standing wall 13 has a square-cornered shape and a curved portion 13b so formed that the back edge of the circumferential end has a curved shape, as shown in FIG. 5. A cutout 13c is formed through the second standing wall 13 in a position slightly apart from the lower end thereof in the circumferential direction (see FIG. 6), and the cutout 13c allows the first recess 15 and the second recess 16 to communicate with each other.

The third standing wall 14 has a cornered portion 14a so formed that the front edge of the circumferential end of the third standing wall 14 has a square-cornered shape and a curved portion 14b so formed that the back edge of the circumferential end has a curved shape, as shown in FIG. 5. The outer circumferential surface of the third standing wall 14 is positioned slightly inside the outer circumferential surface of the second standing wall 13 (see FIGS. 3 and 4).

The second fixed member 8 is fixed by inserting the insertion protrusion 8a forward into the insertion recess 7a of the first fixed member 7. With the second fixed member 8 fixed to the first fixed member 7, the first standing wall 12 has been inserted forward into the clearing recess 11a of the first fixed member 7, and the inner circumferential portion of the second fixed member 8 is so positioned that it protrudes inward more than the first fixed member 7.

The third fixed member 9 has an annular shape whose axis extends in the front-back direction and includes an outer portion 17 positioned on the outer circumferential side and an inner portion 18 positioned on the inner circumferential side. The inner portion 18 protrudes forward from an inner circumferential portion of the outer portion 17.

An annular press-fit recess 17a that is open forward is formed in the outer portion 17. A portion continuous with the inner side of the press-fit recess 17a and protruding forward is provided as part of the outer portion 17 and called an annular sliding protrusion 17b.

A first standing wall 19, a second standing wall 20, and a third standing wall 21, each of which protrudes outward and has an annular shape, are provided in this order from the back side on the outer circumferential surface of the outer portion 17. The first standing wall 19, the second standing wall 20, and the third standing wall 21 are so positioned that they are set apart from each other in the front-back direction; the space between the first standing wall 19 and the second standing wall 20 forms a first recess 22, and the space between the second standing wall 20 and the third standing wall 21 forms a second recess 23.

The front surface of the first standing wall 19 on the outer circumferential side is formed as an opposing surface 19a.

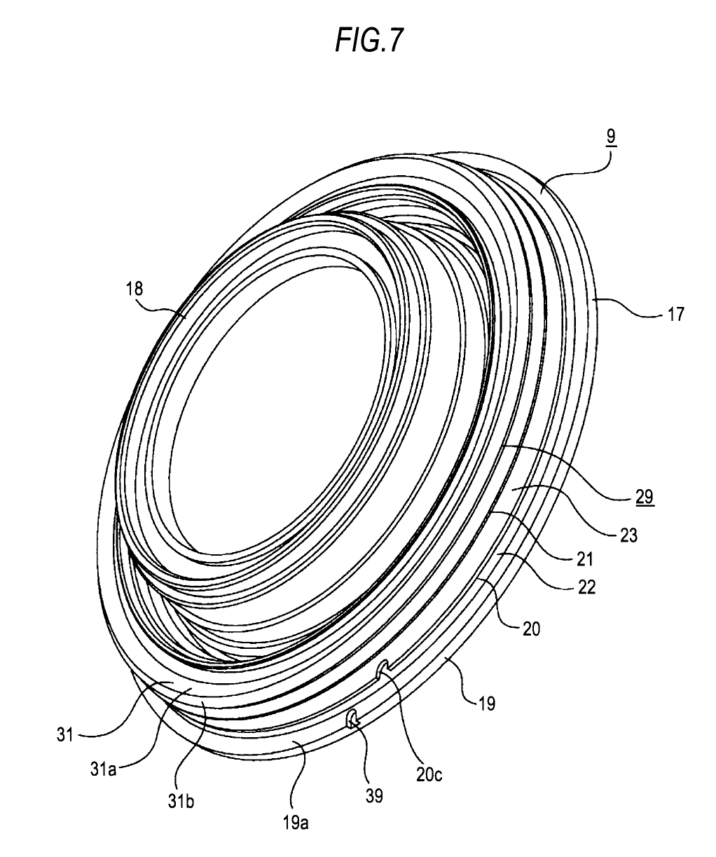

The second standing wall 20 has a cornered portion 20a so formed that the back edge of the circumferential end of the second standing wall 20 has a square-cornered shape and a curved portion 20b so formed that the front edge of the circumferential end has a curved shape, as shown in FIG. 5. The outer circumferential surface of the second standing wall 20 is positioned inside the outer circumferential surface of the first standing wall 19 (see FIGS. 3 and 4). A cutout 20c is formed through the second standing wall 20 in a position slightly apart from the lower end thereof in the circumferential direction (see FIG. 7), and the cutout 20c allows the first recess 22 and the second recess 23 to communicate with each other.

The third standing wall 21 has a cornered portion 21a so formed that the back edge of the circumferential end of the third standing wall 21 has a square-cornered shape and has a curved portion 21b so formed that the front edge of the circumferential end has a curved shape, as shown in FIG. 5. The outer circumferential surface of the third standing wall 21 is positioned slightly inside the outer circumferential surface of the second standing wall 20 (see FIGS. 3 and 4).

Part of the outer circumferential surface of the inner portion 18, specifically, a central portion thereof in the front-back direction, is formed as an annular sliding surface 18a. An annular holding protrusion 18b is provided as part of the inner portion 18 and protrudes forward from an inner circumferential portion thereof.

The third fixed member 9 is fixed with the inner portion 18 thereof abutting the inner circumferential portion of the second fixed member 8 in the forward direction. With the third fixed member 9 fixed to the second fixed member 8, the holding protrusion 18b of the inner portion 18 has been inserted into the placement recess 8c of the second fixed member 8.

An annular sealing rubber 24 is inserted into the placement recess 8c of the second fixed member 8. As a result, the holding protrusion 18b of the inner portion 18 is pressed forward against the sealing rubber 24, which seals the gap between the second fixed member 8 and the third fixed member 9.

A cover lens 25 is attached to the second fixed member 8. An outer circumferential portion of the cover lens 25 is inserted into the attachment recess 8b and attached to the second fixed member 8, for example, with an adhesive.

A first packing 26 is attached to the second fixed member 8. The first packing 26 is made of a rubber or any other elastic material and has an annular shape. The first packing 26 is formed of an attachment portion 27 and a deformable portion 28 protruding from the attachment portion 27 outward and obliquely backward.

The attachment portion 27 has a rectangular cross-section shape.

The deformable portion 28 is formed of a first portion 28a extending outward and obliquely backward and a second portion 28b protruding from a back end portion of the first portion 28a outward and obliquely forward. The deformable portion 28 is so bent and shaped that the first portion 28a and the second portion 28b are substantially perpendicular to each other. A fluorine resin is coated on the back surface of the deformable portion 28.

Since the deformable portion 28 of the first packing 26 is formed of the first portion 28a and the second portion 28b, which is continuous with the first portion 28a and bent relative thereto, as described above, the deformable portion 28 has high rigidity and the first packing 26 will not be plastically deformed or damaged.

The first packing 26 is attached to the second fixed member 8 by press-fitting the attachment portion 27 into the press-fit recess 8d.

A second packing 29 is attached to the third fixed member 9. The second packing 29 is made of a rubber or any other elastic material and has an annular shape. The second packing 29 is formed of an attachment portion 30 and a deformable portion 31 protruding from the attachment portion 30 outward and obliquely forward.

The attachment portion 30 has a rectangular cross-section shape.

The deformable portion 31 is formed of a first portion 31a extending outward and obliquely forward and a second portion 31b protruding from a front end portion of the first portion 31a outward and obliquely backward. The deformable portion 31 is so bent and shaped that the first portion 31a and the second portion 31b are substantially perpendicular to each other. A fluorine resin is coated on the front surface of the deformable portion 31.

Since the deformable portion 31 of the second packing 29 is formed of the first portion 31a and the second portion 31b, which is continuous with the first portion 31a and bent relative thereto, as described above, the deformable portion 31 has high rigidity and the second packing 29 will not be plastically deformed or damaged.

The second packing 29 is attached to the third fixed member 9 by press-fitting the attachment portion 30 into the press-fit recess 17a.

The rotating member 10 is formed of an operation portion 32 and an inner placement portion 33 extending inward from part of the operation portion 32, specifically, a central portion thereof in the front-back direction.

The operation portion 32 has a substantially annular shape having a wide width in the front-back direction and includes a base portion 34 and a protrusion/recess portion 35 having protrusions and recesses alternately arranged in the circumferential direction on the outer circumferential surface of the base portion 34.

An outer end portion of the front surface of the base portion 34 is formed as an opposing surface 34a, and a surface continuous with the inner circumferential side of the opposing surface 34a of the front surface of the base portion 34 is formed as an inclined surface 34b, which inclines backward as extending inward. An outer end of the back surface of the base portion 34 is formed as an opposing surface 34c, and a surface continuous with the inner circumferential side of the opposing surface 34c of the back surface of the base portion 34 is formed as an inclined surface 34d, which inclines forward as extending inward.

Front and back end portions of the lower surface of the base portion 34 are formed as receiving surfaces 34e and 34f, respectively. The receiving surface 34e is formed to incline inward as extending backward, and the receiving surface 34f is formed to incline inward as extending forward.

Parts of the front and back surfaces of the inner placement portion 33, specifically, substantially central portions in the radial direction, are formed as sliding portions 33a and 33b, respectively, and the inner circumferential surface of the inner placement portion 33 is formed as a sliding portion 33c.

The operation portion 32 of the rotating member 10 is positioned between the outer circumferential portion 11 of the first fixed member 7 and the first standing wall 19 of the third fixed member 9, and the inner placement portion 33 is positioned between the second fixed member 8 and the third fixed member 9.

With the operation portion 32 positioned between the outer circumferential portion 11 of the first fixed member 7 and the first standing wall 19 of the third fixed member 9, the opposing surface 11b of the outer circumferential portion 11 and the opposing surface 34a of the operation portion 32 face each other in the front-back direction with a slight gap, that is, a clearance 36, formed therebetween.

Between a lower end portion of the operation portion 32 and a lower end portion of the outer circumferential portion 11 of the first fixed member 7, where the opposing surface 11b and the opposing surface 34a still face each other in the front-back direction, the gap between the opposing surface 11b and the opposing surface 34a is greater than the clearance 36 and forms a discharge hole 37 (see FIGS. 3 and 6).

With the operation portion 32 positioned between the outer circumferential portion 11 of the first fixed member 7 and the first standing wall 19 of the third fixed member 9, the opposing surface 19a of the third fixed member 9 and the opposing surface 34c of the operation portion 32 face each other in the front-back direction with a slight gap, that is, a clearance 38, formed therebetween.

Between the lower end portion of the operation portion 32 and a lower end portion of the first standing wall 19 of the third fixed member 9, where the opposing surface 19a and the opposing surface 34c still face each other in the front-back direction, the gap between the opposing surface 19a and the opposing surface 34c is greater than the clearance 38 and forms a discharge hole 39 (see FIGS. 3 and 7).

The first recess 15 formed in the second fixed member 8 is positioned inside the clearance 36, and the first recess 22 formed in the third fixed member 9 is positioned inside the clearance 38 (see FIGS. 3 and 4). That is, the direction in which the opening of the first recess 15 faces is the direction in which the clearance 36 faces, and the direction in which the opening of the first recess 22 faces is the direction in which the clearance 38 faces.

The receiving surface 34e of the rotating member 10 is positioned outside the second recess 16 of the second fixed member 8, that is, the receiving surface 34e is positioned to face the opening of the second recess 16. Similarly, the receiving surface 34f of the rotating member 10 is positioned outside the second recess 23 of the third fixed member 9, that is, the receiving surface 34f is positioned to face the opening of the second recess 23.

With the inner placement portion 33 positioned between the second fixed member 8 and the third fixed member 9, the deformable portion 28 of the first packing 26 and the deformable portion 31 of the second packing 29 are elastically deformed and pressed against the front and back surfaces of the inner placement portion 33, respectively.

In this state, the deformable portion 28 of the first packing 26 is inclined to the inner placement portion 33, and only a boundary portion between the first portion 28a and the second portion 28b is in contact with the front surface of the inner placement portion 33. Similarly, the deformable portion 31 of the second packing 29 is inclined to the inner placement portion 33, and only a boundary portion between the first portion 31a and the second portion 31b is in contact with the back surface of the inner placement portion 33.

The areas where the first packing 26 and the second packing 29 are in contact with the rotating member 10 are therefore small, that is, each of the first packing 26 and the second packing 29 exerts only a small load on the rotating member 10 when the rotating member 10 is rotated, which ensures smooth rotation of the rotating member 10.

Further, the fluorine resin coated on the back surface of the deformable portion 28 of the first packing 26 and the front surface of the deformable portion 31 of the second packing 29 ensures smooth rotation of the rotating member 10 when it is rotated and reduces the amounts of wear of the inner placement portion 33 of the rotating member 10 and the deformable portions 28 and 31.

With the deformable portion 28 of the first packing 26 pressed against the front surface of the inner placement portion 33 of the rotating member 10, the front end of the second portion 28b is in a position apart backward from the second fixed member 8. In this state, since the deformable portion 28 will not come into contact with the second fixed member 8, the deformable portion 28 will freely deform and the first packing 26 reliably functions in a satisfactory manner.

With the deformable portion 31 of the second packing 29 pressed against the back surface of the inner placement portion 33 of the rotating member 10, the back end of the second portion 31b is in a position apart forward from the third fixed member 9. In this state, since the deformable portion 31 will not come into contact with the third fixed member 9, the deformable portion 31 will freely deform and the second packing 29 reliably functions in a satisfactory manner.

In the optical operation unit 6, which is formed of the rotating member 10 disposed with respect to the first fixed member 7, the second fixed member 8, and the third fixed member 9 as described above, a first internal space 40 is formed between the second fixed member 8 and the rotating member 10 and a second internal space 41 is formed between the third fixed member 9 and the rotating member 10.

Further, in the first internal space 40, the space between the third standing wall 14 of the second fixed member 8 and the deformable portion 28 of the first packing 26 forms a first concave space 42, and in the second internal space 41, the space between the third standing wall 21 of the third fixed member 9 and the deformable portion 31 of the second packing 29 forms a second concave space 43.

The space outside the optical operation unit 6 is called an external space 44, which communicates with the first internal space 40 via the clearance 36 and with the second internal space 41 via the clearance 38.

The sliding portions 33a, 33b, and 33c of the rotating member 10 are so positioned that they face the sliding protrusion 8e of the second fixed member 8, the sliding protrusion 17b of the third fixed member 9, and the sliding surface 18a of the third fixed member 9. As a result, when the rotating member 10 is rotated, the sliding portions 33a, 33b, and 33c can slide relative to the sliding protrusions 8e and 17b and the sliding surface 18a, respectively.

[Entry of Dust and Other Foreign Matter into Internal Space]

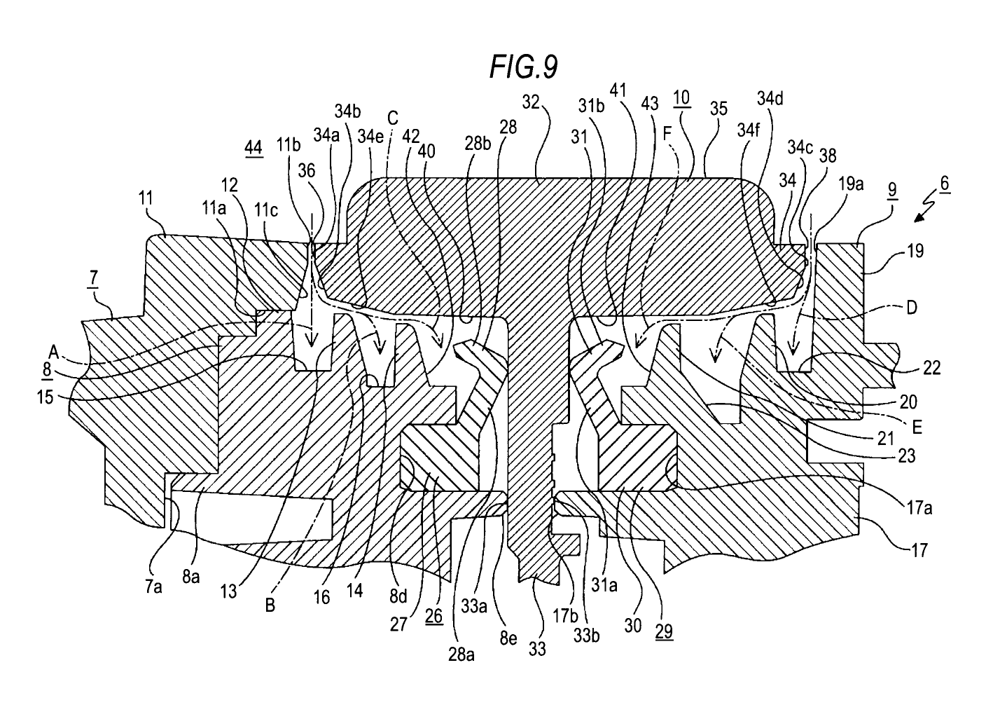

A description will be made of a state in which dust, moisture, and other foreign matter enter the optical operation unit 6 (see FIG. 9).

A state in which dust and other foreign matter enter the first internal space 40 will first be described.

When dust and other foreign matter in the external space 44 enter the first internal space 40 through the clearance 36, much of the dust and other foreign matter having entered the first internal space 40 then enter the first recess 15 (path A in FIG. 9). In consideration of the above, a space continuous with the clearance 36 and formed of the inclined surface 11c of the first fixed member 7 and the inclined surface 34b of the rotating member 10 is configured to widen as extending toward a deep portion of the internal space 40.

As a result, the dust and other foreign matter do not tend to block the gap between the outer circumferential portion 11 of the first fixed member 7 and the operation portion 32 of the rotating member 10, which ensures smooth rotation of the rotating member 10.

In the above description, the space continuous with the clearance 36 and formed of the inclined surface 11c of the first fixed member 7 and the inclined surface 34b of the rotating member 10 is configured to widen as extending toward a deep portion of the first internal space 40 by way of example. The space continuous with the clearance 36 can alternatively be so configured that one of the inclined surface 11c and the inclined surface 34b allows the space to widen as extending toward a deep portion of the first internal space 40.

Further, since the direction in which the opening of the first recess 15 faces is the direction in which the clearance 36 faces, much of the dust and other foreign matter having entered through the clearance 36 can reliably be directed to the first recess 15, whereby the dust and other foreign matter will not reach a deep portion of the first internal space 40.

The dust and other foreign matter having entered the first recess 15 flow downward along the first recess 15 and exit through the discharge hole 37 to the external space 44.

As described above, forming the discharge hole 37, which communicates with the first recess 15 and the external space 44, allows the dust and other foreign matter having entered the first internal space 40 to exit to the external space 44, whereby the dust and other foreign matter will not accumulate in the first internal space 40.

There are dust and other foreign matter that enter from the external space 44 but do not enter the first recess 15, travel over the second standing wall 13, and enter the second recess 16 (path B in FIG. 9). In consideration of the above, the receiving surface 34e of the rotating member 10 is positioned to face the opening of the second recess 16 and formed to incline inward as extending backward.

The dust and other foreign matter traveling over the second standing wall 13 therefore come into contact with the receiving surface 34e and tend to enter the second recess 16, whereby the dust and other foreign matter will not reach a deep portion of the first internal space 40.

Further, the second standing wall 13 has the cornered portion 13a having a square-cornered shape and facing the first recess 15 and the curved portion 13b having a curved shape and facing the second recess 16.

The thus shaped second standing wall 13 does not easily allow the dust and other foreign matter having entered the first recess 15 to travel over the second standing wall 13 toward the second recess 16 but easily allows the dust and other foreign matter having entered the second recess 16 to travel over the second standing wall 13 toward the first recess 15, whereby the amount of dust and other foreign matter that reach a deep portion of the first internal space 40 can be reduced.

The dust and other foreign matter having entered the second recess 16 flow downward along the second recess 16, travel through the cutout 13c of the second standing wall 13 into a lower end portion of the first recess 15, and exit through the discharge hole 37 to the external space 44.

As described above, forming the cutout 13c, which communicates with the first recess 15 and the second recess 16, allows the dust and other foreign matter having entered the first internal space 40 to exit through the cutout 13c to the external space 44, whereby the dust and other foreign matter will not accumulate in the first internal space 40.

Further, the discharge hole 37 and the cutout 13c are formed in positions set apart from each other in the circumferential direction, that is, in the direction in which the rotating member 10 is rotated.

As a result, even when dust and other foreign matter enter the first recess 15 through the discharge hole 37, the dust and other foreign matter having entered the first recess 15 do not tend to enter the second recess 16, whereby the dust and other foreign matter will not reach a deep portion of the first internal space 40.

There are dust and other foreign matter that enter from the external space 44 but do not enter the first recess 15 or the second recess 16, travel over the third standing wall 14, and enter the first concave space 42 (path C in FIG. 9).

As described above, forming the first concave space 42, along with the first recess 15 and the second recess 16, allows the distance of the path along which dust and other foreign matter enter to be increased, whereby entry of the dust and other foreign matter to a deep portion of the first internal space 40 can be suppressed accordingly.

Further, the third standing wall 14 has the cornered portion 14a having a square-cornered shape and facing the second recess 16 and the curved portion 14b having a curved shape and facing the first concave space 42.

The thus shaped third standing wall 14 does not easily allow the dust and other foreign matter having entered the second recess 16 to travel over the third standing wall 14 toward the first concave space 42 but easily allows dust and other foreign matter having entered the first concave space 42 to travel over the third standing wall 14 toward the second recess 16, whereby the amount of dust and other foreign matter that reach a deep portion of the first internal space 40 can be reduced.

The first packing 26 prevents the dust and other foreign matter having entered the first concave space 42 from reaching a deep portion of the first internal space 40.

The first packing 26 disposed behind the first recess 15 and the second recess 16 therefore prevents dust and other foreign matter not having entered the first recess 15 or the second recess 16 from reaching a deep portion of the first internal space 40.

A state in which dust and other foreign matter enter the second internal space 41 will next be described.

When dust and other foreign matter in the external space 44 enter the second internal space 41 through the clearance 38, much of the dust and other foreign matter having entered the second internal space 41 then enter the first recess 22 (path D in FIG. 9). In consideration of the above, a space continuous with the clearance 38 and formed of the inclined surface 34d of the rotating member 10 allows is configured to widen as extending toward a deep portion of the second internal space 41.

As a result, the dust and other foreign matter do not tend to block the gap between the first standing wall 19 of the third fixed member 9 and the operation portion 32 of the rotating member 10, which ensures smooth rotation of the rotating member 10.

In the above description, the space continuous with the clearance 38 and formed of the front surface of the third fixed member 9 in an outer circumferential portion and the inclined surface 34d of the rotating member 10 is configured to widen as extending toward a deep portion of the second internal space 41 by way of example. Alternatively, a surface inclined backward as extending inward can be formed on the third fixed member 9 in the outer circumferential portion, and the space continuous with the clearance 38 formed of the thus formed inclined surface and the inclined surface 34d can be so configured that one of the inclined surface and the inclined surface 34d or the inclined surface formed on the third fixed member 9 in the outer circumferential portion and the inclined surface 34d widen the space as extending toward a deep portion of the second internal space 41.

Further, since the direction in which the opening of the first recess 22 faces is the direction in which the clearance 38 faces, much of the dust and other foreign matter having entered through the clearance 38 can reliably be directed to the first recess 22, whereby the dust and other foreign matter will not reach a deep portion of the second internal space 41.

The dust and other foreign matter having entered the first recess 22 flow downward along the first recess 22 and exit through the discharge hole 39 to the external space 44.

As described above, forming the discharge hole 39, which communicates with the first recess 22 and the external space 44, allows the dust and other foreign matter having entered the second internal space 41 to exit to the external space 44, whereby the dust and other foreign matter will not accumulate in the second internal space 41.

There are dust and other foreign matter that enter from the external space 44 but do not enter the first recess 22, travel over the second standing wall 19, and enter the second recess 23 (path E in FIG. 9). In consideration of the above, the receiving surface 34f of the rotating member 10 is positioned to face the opening of the second recess 23 and formed to incline inward as extending forward.

The dust and other foreign matter traveling over the second standing wall 19 therefore come into contact with the receiving surface 34f and tend to enter the second recess 23, whereby the dust and other foreign matter will not reach a deep portion of the second internal space 41.

Further, the second standing wall 19 has the cornered portion 20a having a square-cornered shape and facing the first recess 22 and the curved portion 20b having a curved shape and facing the second recess 23.

The thus shaped second standing wall 19 does not easily allow the dust and other foreign matter having entered the first recess 22 to travel over the second standing wall 19 toward the second recess 23 but easily allows the dust and other foreign matter having entered the second recess 23 to travel over the second standing wall 19 toward the first recess 22, whereby the amount of dust and other foreign matter that reach a deep portion of the second internal space 41 can be reduced.

The dust and other foreign matter having entered the second recess 23 flow downward along the second recess 23, travel through the cutout 20c of the second standing wall 19 into a lower end portion of the first recess 22, and exit through the discharge hole 39 to the external space 44.

As described above, forming the cutout 20c, which communicates with the first recess 22 and the second recess 23, allows the dust and other foreign matter having entered the second internal space 41 to exit through the cutout 20c to the external space 44, whereby the dust and other foreign matter will not accumulate in the second internal space 41.

Further, the discharge hole 39 and the cutout 20c are formed in positions set apart from each other in the circumferential direction, that is, in the direction in which the rotating member 10 is rotated.

As a result, even when dust and other foreign matter enter the first recess 22 through the discharge hole 39, the dust and other foreign matter having entered the first recess 22 do not tend to enter the second recess 23, whereby the dust and other foreign matter will not reach a deep portion of the second internal space 41.

There are dust and other foreign matter that enter from the external space 44 but do not enter the first recess 22 or the second recess 23, travel over the third standing wall 20, and enter the second concave space 43 (path F in FIG. 9).

As described above, forming the second concave space 43, along with the first recess 22 and the second recess 23, allows the distance of the path along which dust and other foreign matter enter to be increased, whereby entry of dust and other foreign matter into a deep portion of the second internal space 41 can be suppressed accordingly.

Further, the third standing wall 20 has the cornered portion 21a having a square-cornered shape and facing the second recess 23 and the curved portion 21b having a curved shape and facing the second concave space 43.

The thus shaped third standing wall 20 does not easily allow the dust and other foreign matter having entered the second recess 23 to travel over the third standing wall 20 toward the second concave space 43 but easily allows dust and other foreign matter having entered the second concave space 43 to travel over the third standing wall 20 toward the second recess 23, whereby the amount of dust and other foreign matter that reach a deep portion of the second internal space 41 can be reduced.

The second packing 29 prevents the dust and other foreign matter having entered the second concave space 43 from reaching a deep portion of the second internal space 41.

The second packing 29 disposed behind the first recess 22 and the second recess 23 therefore prevents dust and other foreign matter not having entered the first recess 22 or the second recess 23 from reaching a deep portion of the second internal space 41.

### [Outline]

As described above, in the imaging apparatus 1 and the dustproof structure provided therein, the rotating member 10, which is rotated relative to the first fixed member 7, the second fixed member 8, and the third fixed member 9, is provided. Further, the first recess 15 and the second recess 16 are formed in the second fixed member 8, and the first recess 22 and the second recess 23 are formed in the third fixed member 9, the recesses extending in the direction in which the rotating member 10 is rotated and arranged in a direction other than the rotating direction.

The first recess 15, the second recess 16, the first recess 22, and the second recess 23 therefore prevent dust from reaching deep portions of the first internal space 40 and the second internal space 41, which ensures smooth rotation of the rotating member 10 relative to the first fixed member 7, the second fixed member 8, and the third fixed member 9.

Further, since the first recess 15, the second recess 16, the first recess 22, and the second recess 23 are open in the direction perpendicular to the axis of rotation of the rotating member, dust and other foreign matter tend to enter the first recess 15, the second recess 16, the first recess 22, and the second recess 23, whereby entry of the dust into deep portions of the first internal space 40 and the second internal space 41 can be effectively suppressed.

Further, since the first recess 15, the second recess 16, the first recess 22, and the second recess 23 are so formed that they are arranged in the direction perpendicular to the direction in which the rotating member 10 is rotated, dust and other foreign matter having entered through the clearances 36 and 38 do not tend to reach deep portions of the first internal space 40 and the second internal space 41, whereby the entry of the dust into the deep portions of the first internal space and the second internal space 41 can be effectively suppressed.

Moreover, the sliding portions 33a, 33b, and 33c of the rotating member 10 are positioned behind the first packing 26 or the second packing 29 in the first internal space 40 or the second internal space 41.

As a result, dust and other foreign matter will not block the interface between the sliding portion 33a of the rotating member 10 and the sliding protrusion 8e of the second fixed member 8, the interface between the sliding portion 33b of the rotating member 10 and the sliding protrusion 17b of the third fixed member 9, and the interface between the sliding portion 33c of the rotating member 10 and the sliding surface 18a of the third fixed member 9, which ensures smooth rotation of the rotating member 10.

### [Others]

The above description has been made with reference to the case where two recesses, the first recess 15 and the second recess 16, are formed in the second fixed member 8 and other two recesses, the first recess 22 and the second recess 23, are formed in the third fixed member 9, but the number of recesses formed in each of the second fixed member 8 and the third fixed member 9 is not limited to two. Three or more recesses may be formed in each of the second fixed member 8 and the third fixed member 9, and the number of recesses can be arbitrarily determined as long as the recesses are arranged in a direction other than the direction in which the rotating member 10 is rotated.

### [Embodiment of Imaging Apparatus]

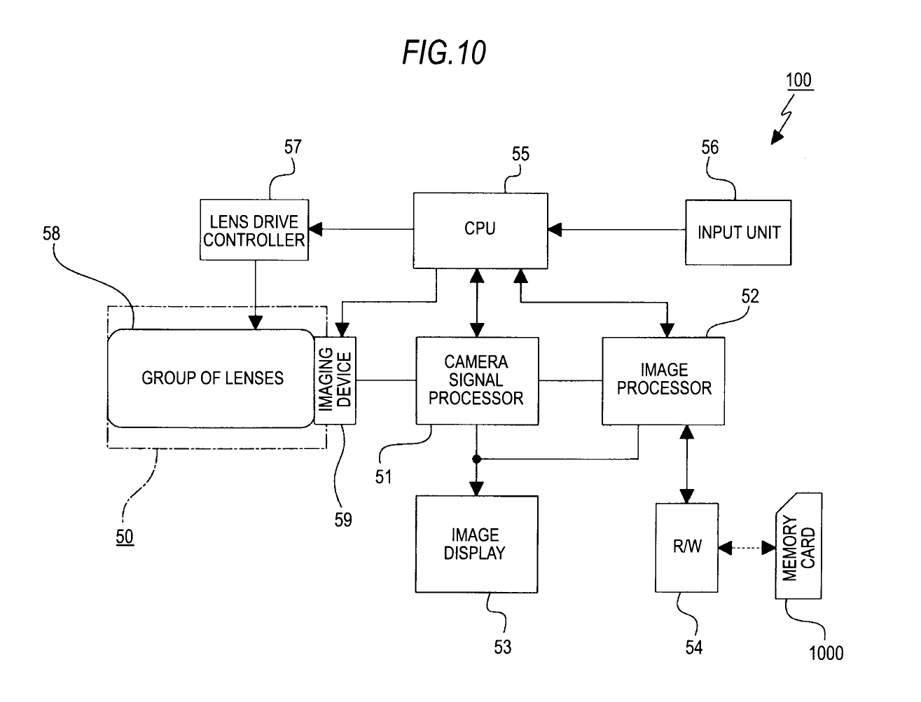

FIG. 10 is a block diagram of the video camcorder as the imaging apparatus according to the embodiment of the present disclosure.

An imaging apparatus (video camcorder) 100 includes a camera block 50 that is responsible for image capturing, a camera signal processor 51 that performs signal processing, such as converting an analog captured image signal into a digital captured image signal, and an image processor 52 that records and reproduces the resultant image signal. The imaging apparatus 100 further includes an image display 53, such as a liquid crystal panel, for displaying a captured image and other information, a R/W (reader/writer) 54 that writes and reads an image signal to and from a memory card 1000, a CPU (central processing unit) 55 that controls the entire imaging apparatus, an input unit 56 formed of a variety of switches and other components operated by a user as necessary, and a lens drive controller 57 that controls and drives lenses disposed in the camera block 50.

The camera block 50 is formed of an optical system including a group of lenses 58, an imaging device 59, such as a CCD (charge coupled device) and a CMOS (complementary metal-oxide semiconductor) device, and other components.

The camera signal processor 51 converts an output signal from the imaging device 59 into a digital signal, performs noise removal and image quality correction, converts the digital signal into brightness/color difference signals, and performs other signal processing.

The image processor 52 performs compression encoding and decompression decoding on an image signal based on a predetermined image data format, performs data format conversion, such as resolution conversion, and performs other image processing.

The image display 53 has a function of displaying a variety of data, such as user's operation through the input unit 56 and captured images.

The R/W 54 writes image data encoded by the image processor 52 to the memory card 1000 and reads image data recorded on the memory card 1000.

The CPU 55 functions as a control processor that controls circuit blocks provided in the imaging apparatus 100 and controls each of the circuit blocks based, for example, on an instruction input signal from the input unit 56.

The input unit 56 is formed, for example, of a shutter release button for shutter operation and a selection switch for selecting an action mode and outputs an instruction input signal according to user's operation to the CPU 55.

The lens drive controller 57 controls a motor or any other actuator (not shown) that drives lenses in the group of lenses 58 based on a control signal from the CPU 55.

The memory card 1000 is, for example, a semiconductor memory that can be attached and detached to and from a slot connected to the R/W 54.

The operation of the imaging apparatus 100 will be described below.

In an image capturing standby state, an image signal captured by the camera block 50 is outputted to the image display 53 via the camera signal processor 51 and displayed as camera-through images on the image display 53 under the control of the CPU 55. When a zooming instruction input signal is inputted from the input unit 56, the CPU 55 outputs a control signal to the lens drive controller 57, and a predetermined lens in the group of lenses 58 is moved under the control of the lens drive controller 57.

When a shutter (not shown) in the camera block 50 is operated in response to an instruction input signal from the input unit 56, the camera signal processor 51 outputs a captured image signal to the image processor 52, which performs compression encoding on the image signal and converts the encoded image signal into digital data expressed in a predetermined data format. The converted data is outputted to the R/W 54, which writes the data to the memory card 1000.

Focusing is carried out as follows. The lens drive controller 57 moves a predetermined lens in the group of lenses 58 based on a control signal from the CPU 55.

To reproduce image data recorded on the memory card 1000, the R/W 54 reads predetermined image data from the memory card 1000 in response to user's operation performed through the input unit 56. The image processor 52 performs decompression decoding on the read image data, and an image signal to be reproduced is then outputted to the image display 53 and displayed as reproduced images.

### [Present Technology]

The present disclosure can also be configured as follows.

(1) A dustproof structure including at least one fixed member disposed in an immobile manner and a rotating member rotatable relative to the fixed member, wherein a clearance is formed between the fixed member and the rotating member, the clearance communicating with an external space positioned outside the fixed member and the rotating member and with an internal space positioned between the fixed member and the rotating member and extending in the direction in which the rotating member is rotated, and a plurality of recesses are formed in the fixed member, the recesses positioned in the internal space, extending in the rotating direction, and arranged in a direction other than the rotating direction.

(2) The dustproof structure according to (1) described above, wherein the recesses are open in the direction perpendicular to the axis of rotation of the rotating member.

(3) The dustproof structure according to (2) described above, wherein among the plurality of recesses, the direction in which the opening of the recess closest to the clearance faces is the direction in which the clearance faces.

(4) The dustproof structure according to any of (1) to (3) described above, wherein the plurality of recesses are formed to be arranged in the direction perpendicular to the rotating direction.

(5) The dustproof structure according to any of (1) to (4) described above, wherein the plurality of recesses are separated by standing walls, an outer edge of each of the standing walls that faces the clearance is a cornered portion having a square-cornered shape, and an outer edge of each of the standing walls that faces a deep portion of the internal space is a curved portion having a curved shape.

(6) The dustproof structure according to any of (1) to (5) described above, wherein the rotating member has a receiving surface formed thereon, the receiving surface positioned in the internal space and so inclined that the receiving surface approaches the axis of rotation of the rotating member as extending toward a deep portion of the internal space, and the receiving surface is positioned to face the opening of at least one of the recesses.

(7) The dustproof structure according to any of (1) to (6) described above, wherein the fixed member has a discharge hole formed therein, the discharge hole communicating with at least one of the recesses and the external space.

(8) The dustproof structure according to (7) described above, wherein the plurality of recesses are separated by standing walls, and a cutout is so formed through each of the standing walls that the cutout allows the recesses adjacent to the standing wall to communicate with each other.

(9) The dustproof structure according to (8) described above, wherein the discharge hole and the cutouts are formed in positions set apart in the direction in which the rotating member is rotated.

(10) The dustproof structure according to any of (1) to (9) described above, wherein a space continuous with the clearance in the internal space is so formed that the space widens as extending toward a deep portion of the internal space.

(11) The dustproof structure according to any of (1) to (10) described above, wherein a packing is disposed in the internal space, the packing having an annular shape and including an attachment portion that is attached to the fixed member and a deformable portion that is elastically deformable and elastically deformed and pressed against the rotating member, and the packing is disposed behind the plurality of recesses in the internal space.

(12) The dustproof structure according to (11) described above, wherein the deformable portion of the packing is positioned to be set apart from the fixed member.

(13) The dustproof structure according to (11) or (12) described above, wherein standing walls that form the recesses are provided in the internal space, and the standing walls and the packing form a concave space disposed next to the recess located in the deepest position in the internal space and extending in the rotating direction.

(14) The dustproof structure according to any of (11) to (13) described above, wherein the deformable portion of the packing is formed of a first portion protruding from the attachment portion and a second portion continuous with the first portion and bent relative thereto.

(15) The dustproof structure according to any of (11) to (14) described above, wherein the rotating member is formed of an operation portion and an inner placement portion, the operation portion having an annular shape and rotated when operated and the inner placement portion extending inward from an inner circumferential surface of the operation portion, and the deformable portion of the packing is so pressed against the inner placement portion of the rotating member that the deformable portion is inclined to the inner placement portion.

(16) The dustproof structure according to (15) described above, wherein a plurality of sliding portions are provided as part of the inner placement portion of the rotating member, the plurality of sliding portions sliding relative to part of the fixed member when the rotating member is rotated relative to the fixed member, and the plurality of sliding portions are positioned behind the packing in the internal space.

The specific shapes and structures of the components shown in the best mode described above are presented only by way of example for implementing the present disclosure and should not be used to construe the technical extent of the present disclosure in a limited sense.

The present disclosure contains subject matter related to that disclosed in Japanese Priority Patent Application JP 2011-029883 filed in the Japan Patent Office on Feb. 15, 2011, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A dustproof structure comprising:
at least one fixed member disposed in an immobile manner; and
a rotating member rotatable relative to the fixed member,
wherein a clearance is formed between the fixed member and the rotating member, the clearance communicating with an external space positioned outside the fixed member and the rotating member and with an internal space positioned between the fixed member and the rotating member and extending in the direction in which the rotating member is rotated, and
a plurality of recesses are formed in the fixed member, the recesses positioned in the internal space, extending in the rotating direction, and arranged in a direction other than the rotating direction.

2. The dustproof structure according to claim 1,
wherein the recesses are open in the direction perpendicular to the axis of rotation of the rotating member.

3. The dustproof structure according to claim 2,
wherein among the plurality of recesses, the direction in which the opening of the recess closest to the clearance faces is the direction in which the clearance faces.

4. The dustproof structure according to claim 1,
wherein the plurality of recesses are formed to be arranged in the direction perpendicular to the rotating direction.

5. The dustproof structure according to claim 1,
wherein the plurality of recesses are separated by standing walls,
an outer edge of each of the standing walls that faces the clearance is a cornered portion having a square-cornered shape, and
an outer edge of each of the standing walls that faces a deep portion of the internal space is a curved portion having a curved shape.

6. The dustproof structure according to claim 1,
wherein the rotating member has a receiving surface formed thereon, the receiving surface positioned in the internal space and so inclined that the receiving surface approaches the axis of rotation of the rotating member as extending toward a deep portion of the internal space, and
the receiving surface is positioned to face the opening of at least one of the recesses.

7. The dustproof structure according to claim 1,
wherein the fixed member has a discharge hole formed therein, the discharge hole communicating with at least one of the recesses and the external space.

8. The dustproof structure according to claim 7,
wherein the plurality of recesses are separated by standing walls, and
a cutout is so formed through each of the standing walls that the cutout allows the recesses adjacent to the standing wall to communicate with each other.

9. The dustproof structure according to claim 8,
wherein the discharge hole and the cutouts are formed in positions set apart in the direction in which the rotating member is rotated.

10. The dustproof structure according to claim 1,
wherein a space continuous with the clearance in the internal space is so formed that the space widens as extending toward a deep portion of the internal space.

11. The dustproof structure according to claim 1,
wherein a packing is disposed in the internal space, the packing having an annular shape and including an attachment portion that is attached to the fixed member and a deformable portion that is elastically deformable and elastically deformed and pressed against the rotating member, and
the packing is disposed behind the plurality of recesses in the internal space.

12. The dustproof structure according to claim 11,
wherein the deformable portion of the packing is positioned to be set apart from the fixed member.

13. The dustproof structure according to claim 11,
wherein standing walls that form the recesses are provided in the internal space, and
the standing walls and the packing form a concave space disposed next to the recess located in the deepest position in the internal space and extending in the rotating direction.

14. The dustproof structure according to claim 11,
wherein the deformable portion of the packing is formed of a first portion protruding from the attachment portion and a second portion continuous with the first portion and bent relative thereto.

15. The dustproof structure according to claim 11,
wherein the rotating member is formed of an operation portion and an inner placement portion, the operation portion having an annular shape and rotated when operated and the inner placement portion extending inward from an inner circumferential surface of the operation portion, and
the deformable portion of the packing is so pressed against the inner placement portion of the rotating member that the deformable portion is inclined to the inner placement portion.

16. The dustproof structure according to claim 15,
wherein a plurality of sliding portions are provided as part of the inner placement portion of the rotating member, the plurality of sliding portions sliding relative to part of the fixed member when the rotating member is rotated relative to the fixed member, and
the plurality of sliding portions are positioned behind the packing in the internal space.

17. An imaging apparatus comprising:
a lens barrel in which an optical system is disposed;
an imaging device that converts an optical image captured through the optical system into an electric signal; and
an optical operation unit that manipulates the optical system,
wherein the optical operation unit includes
at least one fixed member disposed in an immobile manner, and
a rotating member rotatable relative to the fixed member, and
a clearance is formed between the fixed member and the rotating member, the clearance communicating with an external space positioned outside the fixed member and the rotating member and with an internal space positioned between the fixed member and the rotating member and extending in the direction in which the rotating member is rotated, and
a plurality of recesses are formed in the fixed member, the recesses positioned in the internal space, extending in the rotating direction, and arranged in a direction other than the rotating direction.
